(19) United States
(12) Patent Application Publication
(10) Pub. No.: US 2024/0186585 A1
(43) Pub. Date: Jun. 6, 2024

(54) ALL SOLID STATE BATTERY AND METHOD FOR PRODUCING ALL SOLID STATE BATTERY

(71) Applicant: TOYOTA JIDOSHA KABUSHIKI KAISHA, Toyota-shi Aichi-ken (JP)

(72) Inventors: KEISUKE OMORI, Kariya-shi Aichi-ken (JP); Yuhi Yamano, Obu-shi Aichi-ken (JP)

(73) Assignee: TOYOTA JIDOSHA KABUSHIKI KAISHA, Toyota-shi Aichi-ken (JP)

(21) Appl. No.: 18/438,673

(22) Filed: Feb. 12, 2024

Related U.S. Application Data
(63) Continuation of application No. 17/126,690, filed on Dec. 18, 2020.

(30) Foreign Application Priority Data
Dec. 25, 2019 (JP) 2019-234667

(51) Int. Cl. H01M 10/0585; H01M 4/02; H01M 4/04; H01M 4/1395; H01M 4/38; H01M 10/0562

(52) U.S. Cl. CPC H01M 10/0585; H01M 4/043; H01M 4/0471; H01M 4/1395; H01M 4/386; H01M 10/0562; H01M 2004/021; H01M 2004/027; H01M 2300/0071

(57) ABSTRACT

A main object of the present disclosure is to provide an all solid state battery capable of reducing a confining pressure. The present disclosure achieves the object by providing an all solid state battery comprising a cathode active material layer, an anode active material layer including a Si based anode active material, and a solid electrolyte layer formed between the cathode active material layer and the anode active material layer, the anode active material layer includes a void in a region A that is a region of 0.3 μm surrounding a surface of the Si based anode active material, a void ratio in the region A is 10% or more and 70% or less.

### CROSS REFERENCE TO RELATED APPLICATIONS

This nonprovisional application is a continuation application of U.S. patent application Ser. No. 17/126,690 filed on Dec. 18, 2020, which claims priority to Japanese Patent Application No. 2019-234667 filed on Dec. 25, 2019, with the Japan Patent Office, which is incorporated herein by reference in its entirety.

### TECHNICAL FIELD

The present disclosure relates to an all solid state battery and a method for producing an all solid state battery.

### BACKGROUND ART

An all solid state battery is a battery including a solid electrolyte layer between a cathode layer and an anode layer, and has advantages in that it is easy to simplify a safety device as compared with a liquid battery including a liquid electrolyte containing flammable organic solvents.

For example, Patent Literature 1 discloses an all solid state lithium secondary battery using composite active material particles formed by coating sulfide solid electrolyte on active material particles, and discloses that Si is used as active material particles. Patent Literature 2 discloses an all solid state lithium ion battery using a porous active material compact including a void. Further, although it is not an all solid state battery, Patent Literature 3 discloses an anode active material having a structure including a void around Si or Si-alloy.

### CITATION LIST

### Patent Literatures

Patent Literature 1: Japanese Patent Application Laid-Open (JP-A) No. 2016-207418
Patent Literature 2: JP-A No. 2014-154236
Patent Literature 3: WO2019/131519

### SUMMARY OF DISCLOSURE

### Technical Problem

As disclosed in Patent Literature 1, it is known to use a Si-based active material in the all solid state battery. While the Si-based active material has a large theoretical capacitance and is effective for increasing the energy density of the battery, the volume variation thereof during charging and discharging is large, and there is a possibility that the confining pressure of the all solid state battery is increased. The present disclosure has been made in view of the above circumstances, and a main object thereof is to provide an all solid state battery capable of reducing a confining pressure.

### Solution to Problem

In order to achieve the object, the present disclosure provides an all solid state battery comprising a cathode active material layer, an anode active material layer including a Si based anode active material, and a solid electrolyte layer formed between the cathode active material layer and the anode active material layer, the anode active material layer includes a void in a region A that is a region of 0.3 μm surrounding a surface of the Si based anode active material, a void ratio in the region A is 10% or more and 70% or less.

According to the present disclosure, since a void is formed in a region surrounding the Si based anode active material, an all solid state battery capable of reducing a confining pressure may be obtained.

In the disclosure, a void ratio in a region B that is a region excluding a region of the Si based anode active material and the region A from an entire region of the anode active material layer, may be less than the void ratio in the region A.

In the disclosure, the void ratio in the region B may be less than 10%.

In the disclosure, the surface of the Si based anode active material may be coated by a coating portion including the void and a solid electrolyte.

In the disclosure, the solid electrolyte may be an oxide solid electrolyte.

The present disclosure also provides a method for producing an all solid state battery, the method comprising: a preparing step of preparing an anode mixture including a composite anode active material containing a pore-forming material containing layer including a pore-forming material, formed on a surface of a Si based anode active material, an anode mixture layer forming step of forming an anode mixture layer with the anode mixture, a pressing step of pressing the anode mixture layer, and a void forming step of forming a void in a region A that is a region of 0.3 μm surrounding a surface of the Si based anode active material, by removing the pore-forming material from a pressed anode mixture layer.

According to the present disclosure, by using the pore-forming material, an all solid state battery wherein a void is maintained in a region surrounding the surface of the Si based anode active material may be produced.

In the disclosure, a void ratio in the region A may be 10% or more and 70% or less.

In the disclosure, the pore-forming material may be a polymethylmethacrylate resin (PMMA).

In the disclosure, the pore-forming material may be removed by a heat treatment.

### Advantageous Effects of Disclosure

The all solid state battery in the present disclosure exhibits an effect that the confining pressure may be reduced.

### BRIEF DESCRIPTION OF DRAWING

FIG. 1 is a schematic cross-sectional view illustrating an example of an all solid state battery in the present disclosure.

FIGS. 2A and 2B are schematic cross-sectional views illustrating an example of an anode active material layer in the present disclosure.

FIGS. 3A and 3B are cross-sectional SEM images of the anode active material layer in Example 2.

FIG. 4 is a graph showing the results of the confining pressure variation in Examples and Comparative Examples.

### DESCRIPTION OF EMBODIMENTS

An all solid state battery, and a method for producing an all solid state battery in the present disclosure is hereinafter described in detail.

### A. All Solid State Battery

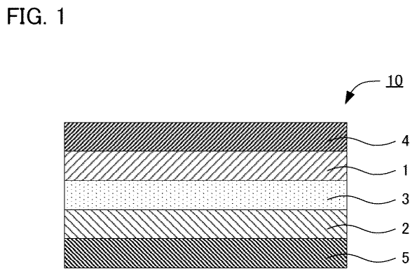

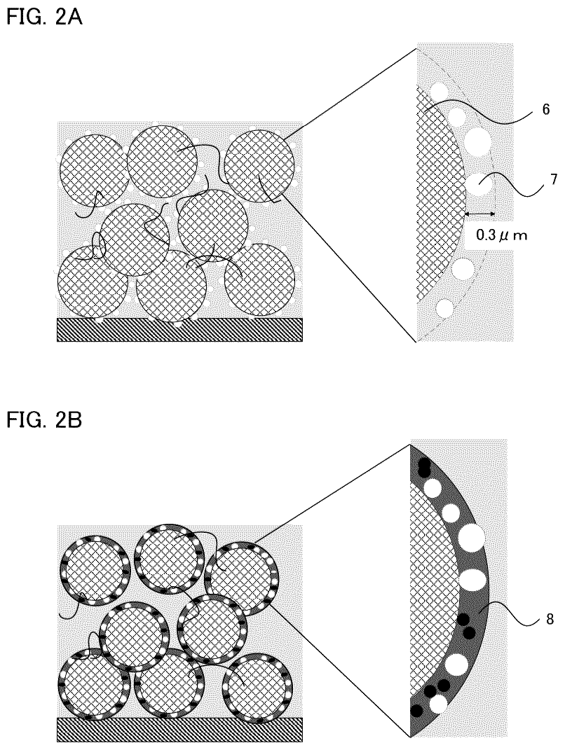

FIG. 1 is a schematic cross-sectional view illustrating an example of an all solid state battery in the present disclosure. Further, FIGS. 2A and 2B are schematic cross-sectional views illustrating an example of an anode active material layer in the present disclosure. All solid state battery 10 shown in FIG. 1 comprises cathode active material layer 1, anode active material layer 2, and solid electrolyte layer 3 formed between cathode active material layer 1 and anode active material layer 2, and also comprises cathode current collector 4 for collecting current of cathode active material layer 1 and anode current collector 5 for collecting current of anode active material layer 2. These members may be housed in a common exterior body. Further, as shown in FIG. 2A, the anode active material layer in the present disclosure includes a Si based anode active material 6 and includes void 7 in a region of 0.3 μm surrounding a surface of Si based anode active material 6, and a ratio of void 7 (void ratio) is in a predetermined range. Further, as shown in FIG. 2B, the surface of Si based anode active material 6 may be coated by coating portion 8.

According to the present disclosure, since a void is formed in a region surrounding the surface of the Si based anode active material, an all solid state battery capable of reducing a confining pressure may be obtained. Further, since it is possible to reduce the confining pressure, the reduction of the energy-density associated with increasing in size of the confining component confining the all solid state battery may also be suppressed. In the field of all solid state battery, for example, an attempt has been made to improve battery performance by using a composite active material in which active material particles are coated with an sulfide based solid electrolyte as in Patent Literature 1. On the other hand, when a high-capacity Si based anode active material is used, expansion and contraction due to charging and discharging tend to be increased, and there is a margin for improvement in reducing the confining pressure of the battery. However, as described above, in the present disclosure, since voids are formed in the region surrounding the Si based anode active material at a predetermined ratio, the confining pressure of the all solid state battery may be reduced.

Here, Patent Literature 2 discloses that a porous active material compact including a void is used for an anode. However, Patent Literature 2 increases the battery capacity by including solid electrolyte in the pores of the active material compact so as to broaden the contact area between the active material compact and the solid electrolyte layer. Therefore, in Patent Literature 2, there is no void in the state of a battery, the use of a non-expanding anode active material such as LTO is assumed, and the use of a Si based anode active material is not assumed. Further, Patent Literature 3 relating to a liquid based battery discloses a production of an anode and a lithium ion battery by using a Si or an Si alloy wherein a structure including a void in the surrounding thereof is preliminarily imparted. In the production of a liquid based battery, a high pressing pressure is not usually imparted. Therefore, if the technique described in Patent Literature 3 is applied to an all solid state battery produced by imparting a high pressing pressure, the void surrounding the Si or Si alloy is collapsed.

### 1. Anode Active Material Layer

The anode active material layer is a layer including Si based anode active material.

Examples of the Si based anode active material may include a Si single substance, a Si alloy, and a Si oxide. In one or more embodiments, the Si alloy includes Si element as a main component. The proportion of the Si element in the Si alloy may be, for example, 50 mol % or more, may be 70 mol % or more, and may be 90 mol % or more. Examples of the Si alloy may include a Si—Al based alloy, a Si—Sn based alloy, a Si—In based alloy, a Si—Ag based alloy, a Si—Pb based alloy, a Si—Sb based alloy, a Si—Bi based alloy, a Si—Mg based alloy, a Si—Ca based alloy, a Si—Ge based alloy, and a Si—Pb based alloy. The Si alloy may be a two-component system alloy, and may be a multi-component system alloy of a three-component or more.

Examples of the shape of the Si based anode active material may be a particulate shape, and a thin film shape. When the Si based anode active material has the particulate shape, the average particle size (D₅₀) of the Si based anode active material is, for example, 1 nm or more, may be 10 nm or more, and may be 1 μm or more. On the other hand, the average particle size (D₅₀) of the Si based anode active material is, for example, 10 μm or less, may be 5 μm or less, and may be 3 μm or less. The average particle size may be determined based on, for example, image analysis using SEM (scanning electron microscope). In one or more embodiments, the number of samples is large, for example, 100 or more.

Also, anode active material layer in the present disclosure includes a void in a region of 0.3 μm surrounding the surface of the Si based anode active material (region A). The “region of 0.3 μm surrounding the surface of the Si based anode active material” means a region from the surface of Si based anode active material to 0.3 μm along the normal line direction toward the outer side of Si based anode active material in the cross-sectional view of the Si based anode active material. The region A is usually defined as a region surrounding the entire circumference of the Si based anode active material. Also, the “surface of the Si based anode active material” does not mean the surface of the coating portion to be described later.

A feature of the anode active material layer in the present disclosure is that the void ratio in the “region of 0.3 μm surrounding the surface of the Si based anode active material”. This region A is a region very close to the surface of the Si based anode active material, and the void in the region A plays an important role in suppressing the volume variation of the Si based anode active material. Also, the void in the region A is formed, for example, by removing a pore-forming material, and the effect of the pore-forming material is remarkably exhibited in the region close to the surface of the Si based anode active material that is coated with the pore-forming material containing layer to be described later. In view of these, the anode active material layer in the present disclosure is characterized by a feature of the void ratio in the “region of 0.3 μm surrounding the surface of the Si based anode active material”.

The void ratio in the region A is 10% or more, may be 20% or more, may be 30% or more, and may be 40% or more. On the other hand, the void ratio in the region A is 70% or less, and may be 60% or less, and may be 50% or less. If the void ratio in the region A is too low, there is a fear that the volume variation of the Si based anode active material may not be sufficiently suppressed, and if the void ratio in the region A is too high, the contact area between the Si based anode active material and solid electrolyte may be reduced and the resistance may be increased.

The void ratio in region A may be determined by, for example, SEM (scanning electron microscope) observation. Specifically, first, a cross-sectional SEM image of the anode active material layer is acquired. An image analysis software is used to clearly distinguish the void from the obtained SEM image, and an area is determined. Then, the void ratio (%) is calculated as the area ratio from the following formula. In one or more embodiments, the number of samples is large, for example, 20 or more, 30 or more, 50 or more, or 100 or more.

Void ratio (%)=100×(void area in region A)/(area of region A)

In one or more embodiments, in the anode active material layer in the present disclosure, the void ratio in a region excluding a region of the Si based anode active material and the region A from an entire region of the anode active material layer (region B), is smaller than the void ratio in the region A. Here, a “region excluding a region of the Si based anode active material and the region A from an entire region of the anode active material layer” refers to a region excluding a region of the cross-section of the Si based anode active material and a region of the cross-section of the region A from the entire region of the cross-section of the anode active material layer.

The void ratio in the region B is, for example, less than 10%, may be 8% or less, may be 5% or less, may be 3% or less, and may be 1% or less. On the other hand, the void ratio in the region B may be 0%, and may be more than 0%. The smaller the void ratio of the region B, the higher the packing ratio the anode active material layer as a whole, and the higher the energy density. Further, the difference in the void ratio between the region A and the region B (the void ratio (%) of the region A—the void ratio (%) of the region B) is, for example, 70% or less, may be 60% or less, may be 50% or less, and may be 40% or less. On the other hand, the above difference is, for example, 1% or more, may be 5% or more, may be 10% or more, may be 20% or more, and may be 30% or more. The void ratio in the region B may be determined by the same method as the void ratio in the region A.

The method for adjusting the void ratio will be explained in “B. Method for producing all solid state battery”.

Further, the surface of the Si based anode active material in the present disclosure may be coated with a coating portion including the void and a solid electrolyte. The coating portion includes a void of at least a part of the void in the region A described above.

Examples of the solid electrolyte may include a sulfide solid electrolyte and an oxide solid electrolyte described later. In one or more embodiments, the solid electrolyte may include the oxide solid electrolyte. This is because the thermal stability of the anode may be improved.

The proportion of the solid electrolyte in the coating portion is, for example, 1% by weight or more, may be 5% by weight or more, and may be 10% by weight or more, when the Si based anode active material is regarded as 100% by weight. On the other hand, the proportion of the solid electrolyte in the coating portion is, for example, 60% by weight or less, may be 40% by weight or less, and may be 20% by weight or less, when the Si based anode active material is regarded as 100% by weight.

The coating portion may include a conductive material as necessary. Examples of the conductive material may include a carbon material. Examples of the carbon material may include particulate carbon materials such as acetylene black (AB) and Ketjen black (KB); and fibrous carbon materials such as carbon fibers, carbon nanotubes (CNTs), carbon nanofibers (CNFs), and vapor-grown carbon fibers (VGCF).

The coverage of the coating portion is, for example, 70% or more, and may be 75% or more, and may be 80% or more. On the other hand, the coverage of the coating portion may be 100%, and may be less than 100%. Coverage of the coating portion may be determined by X-ray photoelectron spectroscopy (XPS) measurement.

The thickness of the coating portion is, for example, 0.05 μm or more, may be 0.3 μm, and may be larger than 0.3 μm. On the other hand, the thickness of the coating portion is, for example, 1 μm or less. The thickness of the coating portion may be determined by observation with a transmission electron microscope (TEM) or a scanning electron microscope (SEM). The thickness of the coating portion may be less than, equal to, or more than 0.3 μm, which is the thickness corresponding to the region A.

The proportion of the anode active material in the anode active material layer is, for example, 20% by weight or more, may be 30% by weight or more, and may be 40% by weight or more. Meanwhile, the proportion of anode active material is, for example, 80% by weight or less, may be 70% by weight or less, and may be 60% by weight or less.

The anode active material layer may include only the Si based anode active material, and may include other anode active material. In the latter case, the proportion of the Si based anode active material in all the anode active material may be 50% by weight or more, may be 70% by weight or more, and may be 90% by weight or more.

Further, the anode active material layer may include at least one of a solid electrolyte, a conductive material, and a binder, if necessary.

Examples of the solid electrolyte may include the same solid electrolyte as those used in the coating portion.

Examples of the binder may include rubber-based binders such as butylene rubber (BR) and styrene butadiene rubber (SBR); and fluoride-based binders such as polyvinylidene fluoride (PVDF).

The thickness of the anode active material layer is, for example, 0.3 μm or more and 1000 μm or less.

### 2. Cathode Active Material Layer

The cathode active material layer includes at least a cathode active material and may optionally include at least one of a solid electrolyte, a conductive material, and a binder. Since the solid electrolyte, the conductive material, and the binder are similar to the contents described in “1. Anode active material layer” above, description thereof will be omitted here.

Examples of the cathode active material may include an oxide active material. Examples of the oxide active material may include rock salt bed type active materials such as LiCoO₂, LiMnO₂, LiNiO₂, LiVO₂, and LiNi_{1/3}Co_{1/3}Mn_{1/3}O₂; spinel type active materials such as LiMn₂O₄, Li₄TisO₁₂, and Li(Ni_{0.5}Mn_{1.5})O₄; and olivine-type active materials such as LiFePO₄, LiMnPO₄, LiNiPO₄, and LiCoPO₄. The surface of the cathode active material may be coated with a Li ion conductive oxide. Examples of the Li ion conductive oxide may include LiNbO₃, Li₄Ti₅O₁₂, and Li₃PO₄.

The proportion of the cathode active material in the cathode active material layer is, for example, 20% by weight or more, may be 30% by weight or more, and may be 40% by weight or more. Meanwhile, the proportion of the cathode active material is, for example, 80% by weight or less, may be 70% by weight or less, and may be 60% by weight or less.

The thickness of the cathode active material layer is, for example, 0.1 μm or more and 1000 μm or less. Examples of a method for forming a cathode active material layer may include a method wherein a mixture containing at least a cathode active material and a dispersion medium is coated and dried.

### 3. Solid Electrolyte Layer

The solid electrolyte layer is a layer formed between the cathode active material layer and the anode active material layer, and includes at least a solid electrolyte. Examples of the solid electrolyte may include an inorganic solid electrolyte such as a sulfide solid electrolyte, an oxide solid electrolyte, a nitride solid electrolyte, and a halide solid electrolyte.

Examples of the sulfide solid electrolyte may include a solid electrolyte containing a Li element, an X element (X is at least one kind of P, As, Sb, Si, Ge, Sn, B, Al, Ga, and In), and a S element. Also, the sulfide solid electrolyte may further include at least one of an O element and a halogen element. Examples of the halogen element may include a F element, a Cl element, a Br element, and an I element.

In one or more embodiments, the sulfide solid electrolyte includes an ion conductor containing an Li element, an A element (A is at least one kind of P, As, Sb, Si, Ge, Al and B), and a S element. Further, in one or more embodiments, the ion conductor has a high Li content.

In addition to the ion conductor, the sulfide solid electrolyte may include a lithium halide. Examples of the lithium halide may include LiF, LiCl, LiBr and LiI. In one or more embodiments, the lithium halide may include LiCl, LiBr and LiI. The proportion of LiX (X═F, I, Cl, Br) in the sulfide solid electrolyte is, for example, 5 mol % or more, and may be 15 mol % or more. On the other hand, the proportion of the Lix is, for example, 30 mol % or less, and may be 25 mol % or less.

Specific examples of the sulfide solid electrolyte may include xLi_{2S}·(100-x)P₂S₅(70≤x≤80), yLiI·zLiBr·(100−y−z) (xLi₂S·(1-x)P₂S₅) (0.7≤x≤0.8, 0≤y≤30, and 0≤z≤30).

Examples of the oxide solid electrolyte may include Li₂O—B₂O₃—P₂O₅, Li₂O—SiO₂, LiLaTaO (such as LisLa₃Ta₂O₁₂), LiLaZrO (such as Li₇La₃Zr₂O₁₂), LiBaLaTaO (such as Li₆BaLa₂Ta₂O₁₂), Li₁₊ₓSiₓP₁₋ₓO₄ (0≤x<1, such as Li_{3.6}Si_{0.6}P_{0.4}O₄)₃, Li₁₊ₓAlₓGe₂₋ₓ (PO₄)₃(0≤x≤2), Li₁₊ₓAlₓTi₂₋ₓ (PO₄)₃(0≤x≤2), and Li₃PO_{(4-3/2x)}Nₓ (0≤x<1).

The thickness of the solid electrolyte layer is, for example, 0.1 μm or more and 1000 μm or less. Examples of a method for forming a solid electrolyte layer may include a method wherein a mixture including at least a solid electrolyte and a dispersion medium is coated and dried.

### 4. Other Configurations

The all solid state battery in the present disclosure comprises at least an anode active material layer, a cathode active material layer and a solid electrolyte layer described above. In addition, it usually comprises a cathode current collector for collecting a current of the cathode active material layer and an anode current collector for collecting a current of the anode active material layer. Examples of a material for the cathode current collector may include SUS, aluminum, nickel, iron, titanium and carbon. On the other hand, examples of the material of the anode current collector may include SUS, copper and nickel. The shapes and thicknesses of the cathode current collector and the anode current collector may be adjusted as appropriate according to the application of the battery.

### 5. All Solid State Battery

In one or more embodiments, the all solid state battery in the present disclosure is an all solid state lithium battery. The all solid state battery may be a primary battery, and may be a secondary battery. In one or more embodiment, the all solid state battery may be a secondary battery. This is because it may be charged and discharged repeatedly, and it is useful, for example, as an in-vehicle battery. The secondary battery also includes a primary battery use of the secondary battery (a use intended for initial charge only).

The all solid state battery in the present disclosure may be a single cell battery, and may be a stacked battery. The stacked battery may be a monopolar type stacked battery (stacked battery of the parallel connection type), and may be a bipolar type stacked battery (stacked battery of the series connection type). Examples of the shape of the all solid state battery may include coin-shaped, laminated, cylindrical, and square.

The all solid state battery in the present disclosure may be produced by “B. Method for producing all solid state battery” described later.

### B. Method for Producing all Solid State Battery

The method for producing an all solid state battery in the present disclosure comprises a preparing step of preparing an anode mixture including a composite anode active material containing a pore-forming material containing layer including a pore-forming material, formed on a surface of a Si based anode active material, an anode mixture layer forming step of forming an anode mixture layer with the anode mixture, a pressing step of pressing the anode mixture layer, and a void forming step of forming a void in region A that is a region of 0.3 μm surrounding a surface of the Si based anode active material, by removing the pore-forming material from a pressed anode mixture layer.

According to the present disclosure, by using the pore-forming material, an all solid state battery wherein a void is maintained in a region surrounding the surface of the Si based anode active material may be produced. In addition, it is possible to make the region B in anode active material layer dense. In the liquid based battery as shown in Patent Literature 3, the void need not be formed by using pore-forming material in the first place. This is because the void ratio in the liquid based battery may be controlled in the pressing process in the production of the electrode.

### 1. Preparing Step

Preparing step is a step of preparing an anode mixture including a composite anode active material containing a pore-forming material containing layer including a pore-forming material, formed on a surface of a Si based anode active material. Since the Si based anode active material is similar to the contents described in “1. Anode active material layer” above, description thereof will be omitted here.

The pore-forming material is a material that forms a void in the region A described above.

The pore-forming material is not particularly limited, and conventionally known materials may be used. In one or more embodiments, the pore-forming material is decomposed by heat. In one or more embodiments, the thermal decomposition temperature of the pore-forming material is equal to or lower than the temperature at which the solid electrolyte is deteriorated, and is, for example, 600° C. or less. Examples of the pore-forming material may include acrylic resins such as polymethyl methacrylate resin (PMMA); polystyrene; and polysiloxane based thermosetting resins.

The average particle size of the pore-forming material is, for example, 0.05 μm or more and 100 μm or less.

Further, the pore-forming material containing layer may contain at least one of a solid electrolyte and a conductive material if necessary. When the pore-forming material containing layer contains the solid electrolyte, the pore-forming material containing layer in the all solid state battery is the coating portion described above. Since the types of the solid electrolyte and the conductive material are similar to the contents described in “1. Anode active material layer” above, description thereof will be omitted here.

In preparing step in the present disclosure, a composite anode active material may be purchased from another person and prepared, and may be prepared by oneself. In the latter case, the pore-forming material containing layer may be formed on the surface of the Si based anode active material by performing a compressive shear treatment to the mixture containing the Si based anode active material and the pore-forming material. Thus, the above described composite anode active material is obtained. Further, the mixture may include the above described solid electrolyte and conductive material. The conditions of the compressive shear process may be appropriately set.

The proportion of the pore-forming material in the mixture is, for example, 5% by weight or more, and may be 10% by weight or more, when the Si based anode active material is regarded as 100% by weight. On the other hand, the proportion of pore-forming material is, for example, 40% by weight or less, may be 30% by weight or less, and may be 20% by weight or less. By adjusting the proportion of the pore-forming material, the void ratio in the region A and the differences in the void ratio between the region B and the region A may be adjusted.

When the solid electrolyte is not included, the thickness of the pore-forming material containing layer is equal to the particle size of the pore-forming material. Also, when the solid electrolyte is included, the thickness of the pore-forming material layer is similar to the thickness of the coating portion described in “1. Anode active material layer” above.

The anode mixture includes at least the above described composite anode active material, and may include at least one of a solid electrolyte, a conductive material, and a binder if necessary. Since the solid electrolyte, the conductive material, and the binder are similar to the contents described in “1. Anode active material layer” above, description thereof will be omitted here.

Examples of a method for preparing an anode mixture may include a method wherein the above described materials are dispersed in a dispersion medium such as heptane.

### 2. Anode Mixture Layer Forming Step

The anode mixture layer forming step is a step of forming an anode mixture layer with the anode mixture.

Examples of a method for forming an anode mixture layer may include a method wherein a substrate is coated with the anode mixture, and dried. Examples of a method for coating may include a screen printing method, a gravure printing method, a die coating method, a doctor blade method, an ink jet method, a metal mask printing method, an electrostatic painting method, a DIP coating method, a spray coating method, and a roll coating method. The substrate to which the anode mixture is coated is not particularly limited, and examples thereof may include an anode current collector and a transfer sheet.

### 3. Pressing Step

The pressing step is a step of pressing the anode mixture layer.

The pressing method is not particularly limited as long as the pressure may be applied to the anode mixture layer, and examples may include a roll press. The linear pressure applied at the time of pressing is, for example, 15 kN/cm or more and 50 kN/cm or less.

### 4. Void Forming Step

The void forming step is a step of forming a void in region A that is a region of 0.3 μm surrounding a surface of the Si based anode active material, by removing the pore-forming material from a pressed anode mixture layer. Since the “region A” is similar to the contents described in “1. Anode active material layer” above, description thereof will be omitted here.

In addition, in the void forming step, the pore-forming material may be removed so that the void ratio in the region A is 10% or more and 70% or less.

The method for removing the pore-forming material is not particularly limited as long as the pore-forming material may be removed from the anode mixture layer, and may be appropriately selected depending on the type of the pore-forming material. For example, when the pore-forming material is decomposed thermally, the method for removing the pore-forming material may be a heat treatment. The heat treatment may be a treatment in which a temperature equal to or higher than the thermal decomposition temperature of the pore-forming material is applied for a predetermined time.

In the void forming step, all of the pore-forming material included in the anode mixture layer may be removed, and a part of the pore-forming material may be removed. In one or more embodiments, all of the pore-forming material included in the anode mixture layer may be removed. This is because the void ratio may be easily adjusted by the thickness of pore-forming material containing layer and the coating portion and the added amount of the pore-forming material.

### 5. Other Steps

In the method for producing an all solid state battery in the present disclosure, an anode may be formed by the above described steps. In addition, the method for producing an all solid state battery usually comprises a cathode forming step of forming a cathode, and a solid electrolyte layer forming step of forming a solid electrolyte layer. In addition, it usually comprises an assembling step of assembling a stack including a cathode, a solid electrolyte layer and an anode, produced as described above, in this order. In the method for producing an all solid state battery in the present disclosure, an anode precursor may be formed by the above described preparing step, anode mixture layer forming step, and pressing step, and a stack including a cathode, a solid electrolyte layer, and the anode precursor in this order may be assembled, and then, the void forming step may be performed.

### 6. All Solid State Battery

The all solid state battery produced by the above described method is similar to that described in “A. all solid state battery” above, and therefore, description thereof is omitted here.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

### <Preparation of Composite Anode Active Material>

To a particle compounding device (NOB-MINI, manufactured by Hosokawa Micron Corporation), Si particles (average particle size: 5 μm) as an anode active material and PMMA (specific gravity: 1.2 g/cm³, average particle size: 0.3 μm) were charged in the amounts shown in Table 1 below. A compressive shear treatment was performed by setting the distance between the rotating blades, the inner wall of the treatment vessel, of the compressive shear rotor to 1 mm, the blade peripheral speed to 25 m/s, and the treatment time to 20 minutes to obtain a compound anode active material.

### <Preparation of Anode>

The composite anode active material was charged into a dispersion medium (heptane) in an amount of 50% by weight, a sulfide solid electrolyte (10LiI-15LiBr-75 (0.75Li₂S-0.25P₂S₅)) in an amount of 37% by weight, a conductive material (VGCF) in an amount of 10% by weight, and a binder (PVdF) in an amount of 3% by weight. To this dispersion medium, an ultrasonic treatment was performed using an ultrasonic homogenizer for 5 minutes to obtain an anode mixture. A current collector foil (SUS, 25 μm thickness) was coated with the anode mixture and dried, and then, roll pressed at a linear pressure of 50 kN/cm. The obtained current collector foil with the anode mixture layer was punched to a diameter of 13.29 mm (1.4 cm²). Thereafter, PMMA was removed by a heat treatment at 430° ° C. for 5 minutes to obtain an anode (current collector foil with an anode active material layer).

### <Preparation of Evaluation Battery>

To a dispersion medium (heptane), 84.7% by weight of a cathode active material (LiNi_{1/3}CO_{1/3}Mn_{1/3}O₂), 13.4% by weight of a sulfide solid electrolyte (10LiI-15LiBr-75(0.75Li₂S-0.25P₂S₅)), 1.3% by weight of a conductive material (VGCF), and 0.6% by weight of a binder (PVdF) were charged. To this dispersion medium, an ultrasonic treatment was performed using an ultrasonic homogenizer for 5 minutes to obtain a cathode mixture. A current collector foil (Al foil, 20 μm thickness) was coated with the cathode mixture and dried, and then, roll pressed at a linear pressure of 50 kN/cm. The obtained current collector foil with the cathode mixture layer was punched into a diameter of 11.3 mm (1 cm²) to obtain a cathode.

To a dispersion medium (heptane), 99.5% by weight of a sulfide solid electrolyte (10LiI-15LiBr-75(0.75Li₂S-0.25P₂S₅)) and 0.5% by weight of a binder (PVdF) were charged. To this dispersion medium, an ultrasonic treatment was performed using an ultrasonic homogenizer for 5 minutes to obtain a mixture. A substrate (Al foil, 20 μm thickness) was coated with the obtained mixture so as to have a thickness of 15 μm and dried, and then, punched into a diameter of 13.3 mm (1.4 cm²) to obtain a solid electrolyte layer (separator layer).

The cathode, the separator layer, and the anode were stacked with their centers aligned, and the layers were adhered to each other at a surface pressure of 5 ton/cm². Thereafter, sealed with tabbed laminate and confined under 5 MPa, to produce an evaluation battery (all solid state lithium battery). The capacitance of the evaluating battery was made to be 2 mAh.

### Examples 2 to 4

An evaluation battery was obtained in the same manner as in Example 1 except that the amount of PMMA was changed as shown in Table 1 in the preparation of the composite anode active material.

### Examples 5 and 6

A composite anode active material (coated composite anode active material) was prepared in the same manner as in Example 1 except that oxide solid electrolyte (Li₂O—B₂O₃—P₂O₅, average particle size: 0.1 μm) was used, and the amount of PMMA was changed as shown in Table 1 in the preparation of the composite anode active material. The coated composite anode active material in an amount of 55% by weight, a sulfide solid electrolyte (10LiI-15LiBr-75 (0.75Li₂S-0.25P₂S₅)) in an amount of 32% by weight, a conductive material (VGCF) in an amount of 10% by weight, and a binder (PVdF) in an amount of 3% by weight were charged into a dispersion medium (heptane). To this dispersion medium, an ultrasonic treatment was performed using an ultrasonic homogenizer for 5 minutes to obtain an anode mixture. An evaluation battery was produced in the same manner as in Example 1 except that an anode was produced using this anode mixture.

### Comparative Example 1

An evaluation battery was obtained in the same manner as in Example 1 except that the amount of PMMA was changed as shown in Table 1 in the preparation of the composite anode active material.

### Comparative Example 2

An evaluation battery was obtained in the same manner as in Example 1 except that Si particles (average particle size: 5 μm) were used instead of the composite anode active material.

### Comparative Example 3

An evaluation battery was obtained in the same manner as in Example 6 except that no PMMA was used in the preparation of the composite anode active material, and an oxide solid electrolyte (Li₂O—B₂O₃—P₂O₅, average particle size: 0.1 μm) was used.

TABLE 1

| | Si particle | PMMA | Li₂O—B₂O₃—P₂O₅ |
|---|---|---|---|
| | (g) | (g) | (g) |
| Comp. Ex. 1 | 27 | 0.7 | — |
| Example 1 | 27 | 1.4 | — |
| Example 2 | 27 | 2.8 | — |
| Example 3 | 27 | 7.0 | — |
| Example 4 | 27 | 9.8 | — |
| Example 5 | 27 | 1.4 | 2.9 |
| Example 6 | 27 | 2.8 | 2.9 |

### [Evaluation]

### <Void Ratio>

Cross-sectional SEM images of the anode active material layers obtained in Examples 1 to 6 and Comparative Examples 1 to 3 were obtained. This cross-sectional SEM image was subjected to image processing, and the void ratio in region A that is a region of 0.3 μm surrounding a surface of the Si based anode active material was calculated from the following formula.

Void ratio (%)=100×(void area in region A)/(area of region A)

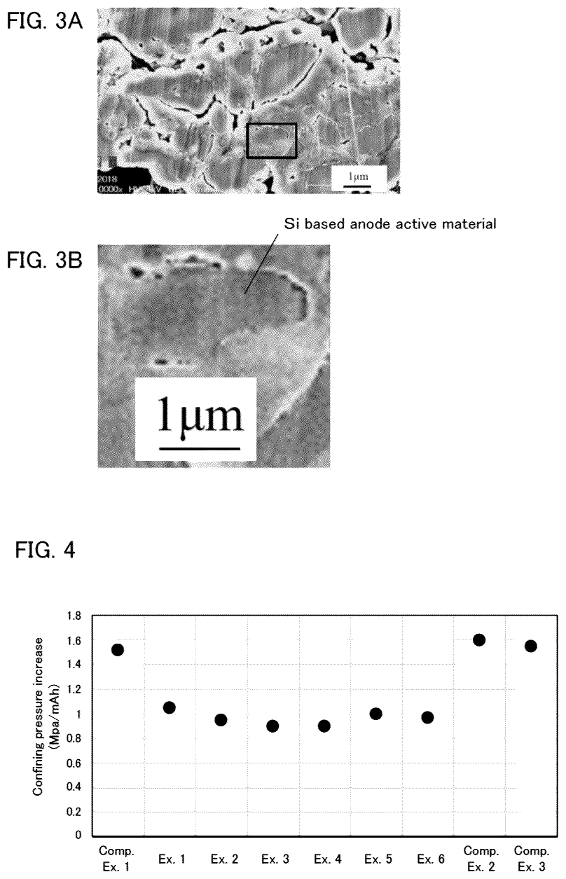

The results are shown in Table 2. Incidentally, a value of the amount of PMMA added in each of the Examples and Comparative Examples in volume ratio with respect to the Si particle is also shown in Table 2. Also, the cross-sectional SEM images obtained in Example 2 are shown in FIGS. 3A and 3B.

TABLE 2

| | Added PMMA amount (%) | Oxide SE | Void (%) | |
|---|---|---|---|---|
| | (in volume ratio vs Si) | coating | Area A | Area B |
| Comp. Ex. 1 | 5 | Not coated | 4.8 | 4.8 |
| Example 1 | 10 | Not coated | 9.7 | 5.2 |
| Example 2 | 20 | Not coated | 22.0 | 5.3 |
| Example 3 | 60 | Not coated | 61.2 | 5.1 |
| Example 4 | 70 | Not coated | 71.2 | 5.1 |
| Example 5 | 10 | Coated | 9.9 | 5.0 |
| Example 6 | 20 | Coated | 20.1 | 5.1 |
| Comp. Ex. 2 | — | Not coated | 1.2 | 5.2 |
| Comp. Ex. 3 | — | Coated | 2.0 | 5.1 |

FIG. 3B is an enlarged view of a part of FIG. 3A. As shown in FIG. 3B, it was confirmed that voids were formed in the area surrounding the active material. Further, as shown in Table 2, in Comparative Example 1 and Examples 1 to 6, it was confirmed that the void ratio in the region A was correlated with the amount of PMMA added, and the void in the region A was derived from the pore-forming material (PMMA). Further, since the pore-forming material was removed after pressing the anode mixture layer, it was confirmed that the void ratio in the region B was lower than the region A, and the packing ratio was high as the entire anode active material layer.

### <Confining Pressure Variation>

The evaluation batteries obtained in Examples 1 to 6 and Comparative Examples 1 to 3 were subjected to a charge/discharge test. The conditions of the charge/discharge test were as follows: the confining pressure (sizing) of 5 MPa, charged at 0.1 C, discharged at 1 C, and cut-off voltage of 3.0 V to 4.55 V. The initial charging capacity and the initial discharging capacity were determined. The results are shown in FIG. 4. Also, the confining pressure of the evaluation battery was monitored during the first charge, and the confining pressure at 4.55 V was measured to determine the confining pressure increase from the condition prior to charging and discharging.

As shown in FIG. 4, in Examples 1 to 6, the confining pressure variation was remarkably suppressed as compared with Comparative Examples 1 to 3. From this, it was confirmed that the confining pressure may be reduced in the all solid state battery in the present disclosure.

### <Thermal Stability>

The evaluation batteries obtained in Examples 1, 2, 5 and 6 were charged, then, the anodes in the charge state was taken out, and the temperature of the heat generation peak up to 400° ° C. of the taken out anodes were compared by a differential scanning calorimetry (DSC). The results are shown in Table 3.

TABLE 3

| | First | Second | Third |
|---|---|---|---|
| | exothermal peak | exothermal peak | exothermal peak |
| | Temperature | Temperature | Temperature |
| | (° C.) | (° C.) | (° C.) |
| Example 1 | 185 | 279 | 319 |
| Example 2 | 185 | 276 | 310 |
| Example 5 | 192 | 291 | 320 |
| Example 6 | 198 | 297 | 322 |

As shown in Table 3, it was confirmed that the thermal stability was improved in Examples 5 and 6 in which the surface of the Si based anode active material was coated with a coating portion including an oxide solid electrolyte.

### REFERENCE SIGNS LIST

1 . . . cathode active material layer
2 . . . anode active material layer
3 . . . solid electrolyte layer
4 . . . cathode current collector
5 . . . anode current collector
6 . . . Si based anode active material
7 . . . void
8 . . . coating portion
10 . . . all solid state battery

What is claimed is:

1. A vehicle comprising an all solid state battery, wherein the all solid state battery comprises a cathode active material layer, an anode active material layer including a Si based anode active material, and a solid electrolyte layer formed between the cathode active material layer and the anode active material layer,
the anode active material layer includes a void in a region A that is a region of 0.3 μm surrounding a surface of the Si based anode active material,
a void ratio in the region A is 10% or more and 70% or less.

2. The vehicle according to claim 1, wherein a void ratio in a region B that is a region excluding a region of the Si based anode active material and the region A from an entire region of the anode active material layer, is less than the void ratio in the region A.

3. The vehicle according to claim 2, wherein the void ratio in the region B is less than 10%.

4. The vehicle according to claim 1, wherein the surface of the Si based anode active material is coated by a coating portion including the void and a solid electrolyte.

5. The vehicle according to claim 4, wherein the solid electrolyte is an oxide solid electrolyte.
